(19) United States
(12) Patent Application Publication
(10) Pub. No.: US 2016/0205630 A1
(43) Pub. Date: Jul. 14, 2016

(54) Enhanced Mechanism to Access the Network for Mobile Terminal

(71) Applicant: Media Rek Singapore Pte. Ltd., Singapore (SG)

(72) Inventors: Li CHEN, Beijing (CN); Chia-Chun HSU, New Taipei City (TW); Yuanyuan ZHANG, Beijing (CN); Chie-Ming CHOU, Qingshui Town, Taichung County (TW)

(21) Appl. No.: 14/914,145

(22) PCT Filed: May 18, 2015
(86) PCT No.: PCT/CN2015/079215

§ 371 Date: Feb. 24, 2016

(30) Foreign Application Priority Data
May 16, 2014 (CN) 201410207283.7

(51) Int. Cl. H04W 52/02; H04W 76/04

(52) U.S. Cl. CPC H04W 52/0251; H04W 76/046; H04W 88/02

(57) ABSTRACT

In order to optimize UE power consumption, the embodiments of present invention adopt the Power Saving Mode (PSM) solution. In NAS layer, an active timer is defined for PSM. UE starts the active timer when it transits from CONNECTED to IDLE. When the active timer expires, UE transits from IDLE to PSM. UEresumes IDLE before the periodic TAU timer expires. During PSM, the UE may resume IDLE any timer, e.g., for mobile originating communication. A new mechanism to access the network for the UE is proposed in this invention. This mechanism defines the UE behaviors when it transits from PSM to IDLE and to establish RRC connection. First of all, UE performs cell selection/reselection by considering the previous serving cell. Then the access barring timer is controlled by comparing the current and the previous serving cell. The RRC connection is established based on the status of access barring timer.

### CROSS REFERENCE TO RELATED APPLICATIONS

The disclosed embodiments of this application claims priority from Chinese Application Number CN 201410207283.7, entitled, “Enhanced mechanism to access the network for mobile terminal” filed on May, 16, 2014; the subject matter of which is incorporated herein by reference.

### TECHNICAL FIELD

The disclosed embodiments relate generally to wireless communication, and, more particularly, to an enhanced mechanism to access the network for UEs.

### BACKGROUND

Extending the reach of wireless communication is a challenge for all types of network, especially in the rural or remote areas. Due to the nature of the radio environment, services and power are difficult to deliver. It is both impractical and uneconomical to deliver coverage using a traditional base station approach. Taking LTE for example, it will be deployed at higher carrier frequencies than existing 2G and 3G systems, which implies higher propagation losses for LTE and potentially a need to add more sites to ensure sufficiently good coverage. Adding sites is costly and requires lengthy negotiations. Machine-to-Machine (M2M) applications required low-cost devices and improved coverage other than the current cellular communication system. For example, some smart metering deceives are often installed in the basements of residential buildings or locations shielded by foil-backed insulation, metalized windows, or traditional thick-walled building construction. These smart devices suffer a significantly larger path-loss, such as 20 dB path loss, than that in the typical operation condition of normal devices. In order to ensure the network provides the best possible solutions to maximize coverage and serves the specific devices, the 3rd generation partnership project (3GPP) RAN1 working group has studied for coverage improvement for devices requiring coverage extension/coverage enhancement (CE). Some potential solutions have been identified such as repetition of the physical channels to improve the coverage.

One of the important problems is the power consumption. Improvement and enhancement are required to efficiently reduce the power consumption of the UEs requiring CE in the wireless network.

### SUMMARY

Methods and apparatus are provided for access the network for the mobile terminal.

A new mechanism to access the network for the mobile terminal is proposed in this invention. This mechanism defines the mobile terminal behaviors when it returns from PSM to IDLE and to establish a RRC connection. First of all, the mobile terminal performs cell selection/reselection by considering the previous serving cell camping on. After that, the access barring timer is controlled by comparing the current serving cell and the previous serving cell. The RRC connection is established based on the status of access barring timer. The mechanism proposed in this invention can consider the barring status of the cell before the mobile terminal enters PSM as the network desired.

In one novel aspect, a method is provided comprising: entering into a PSM status by a UE in a mobile communication system; performing a cell selection/reselection to select a cell to camp on when the UE transits from the PSM status to an IDLE status; comparing the cell being camped on and the previous serving cell; checking the status of a access barring timer; and establishing a RRC connection based on the status of access barring timer and the result of the comparison. The access barring timer comprises one of the following timers, T302, T303, T305 and T306. The access barring timer is activated when one of the following conditions occur: the RRC connection is established, the RRC connection quest is rejected, and the RRC connection is barred. In one example, establishing a RRC connection based on the status of access barring timer and the result of the comparison further comprising: establishing a RRC connection when the access barring timer expires or stopped. In another example, wherein when a selected cell is not the a previous serving cell camped on when the last time the mobile terminal transits from IDLE to PSM, or the serving cell during the cell resection, the access barring timer is stopped.

In another novel aspect, wherein when a selected cell is a previous serving cell camped on when the last time the mobile terminal transits from IDLE to PSM, or the serving cell during the cell resection, the access barring timer is kept running. And when the access barring timer is stopped or expires, the information about barring alleviation is informed to the upper layer by the UE.

In yet another novel aspect, an user equipment(UE) is provided, comprising: cell selection module, for performing a cell selection/reselection to select a cell to camp on when the UE transits from the PSM status to an IDLE status and comparing the cell being camped on and the previous serving cell; timer handler for checking the status of a access barring timer; RRC module, for establishing a RRC connection based on the status of access barring timer and the result of the comparison.

Other embodiments and advantages are described in the detailed description below. This summary does not purport to define the invention. The invention is defined by the claims.

### BRIEF DESCRIPTION OF DRAWINGS

The accompanying drawings, where like numerals indicate like components, illustrate embodiments of the invention.

FIG. 1 illustrates an exemplary wireless communication network with UEs requiring coverage extension in accordance with embodiments of the current invention.

FIG. 2 illustrates an example of the state transition for PSM

FIG. 3 illustrates the interaction between NAS layer and AS layer.

FIG. 4 illustrates an example of a UE accesses the network with running access barring timer (camp on a same cell)

FIG. 5 illustrates an example of a UE accesses the network with running access barring timer (camp on a different cell)

FIG. 6 illustrates an example of T302 expiry before transition from PSM to IDLE

FIG. 7 illustrates an example of T302 expiry before transition from PSM to IDLE

FIG. 8 illustrates method flow for a UE accesses the network with running access barring timer

FIG. 9 illustrates an example of a UE accesses the network with stopping access barring timer

FIG. 10 illustrates a method flow of a UE accesses the network with stopping access barring timer.

FIG. 11 illustrates another method flow of a UE accesses the network according to the access barring timer.

### DETAILED DESCRIPTION

In the past several years, the number of cellular M2M (Machine to Machine) subscribers increased a lot, due to the increasingly mature M2M market. Smart-metering is one of the typical M2M applications. In 3rd generation partnership project (3GPP), RAN2, CT1, SA2 working groups are studying on the power consumption of mobile terminal. Power consumption is important for mobile terminals using battery and also for mobile terminal using external power supply and its importance increases with the continued growth of device populations and more demanding use cases. The importance can be illustrated by many scenarios. In 3GPP TR 23.887, there are 5 possible types of solutions that could be proposed in UE Power Consumption Optimizations (UEPCOP). The introduction of Power Saving Mode (PSM) is one of the solutions when there are longer periods of inactivity (in the range of multiple minutes or hours). The basic idea behind the solution is that a UE can be configured so that the UE is reachable for downlink data only during the time that the UE is in RRC/S1 connected state plus an active time period that follows the connected state during which the UE is reachable for paging, i.e. the active timer period is after the UE changed to idle state. The UE starts the active timer after transiting to the idle state. When the active timer expires, the UE changes to a PSM. Depending on device configuration the applications of the device may change the device back to normal network operation mode, e.g. when an application of the device needs to transfer data. The enhanced mechanism for the mobile terminal to access the network is not limited to the examples above. To optimize mobile terminal power consumption, one of embodiment of this invention adopts the Power Saving Mode (PSM) solution. In NAS layer, an active timer is defined for PSM. The mobile terminal starts the active timer when it goes from CONNECTED mode to IDLE mode. When the active timer expires, the mobile terminal returns from IDLE mode to PSM mode. The mobile terminal returns back to IDLE mode before the periodic TAU timer expires. During PSM mode, the UE may return to IDLE mode any time, e.g., for mobile originating communication. The introduction of PSM has some impact to the current design for the LTE system.

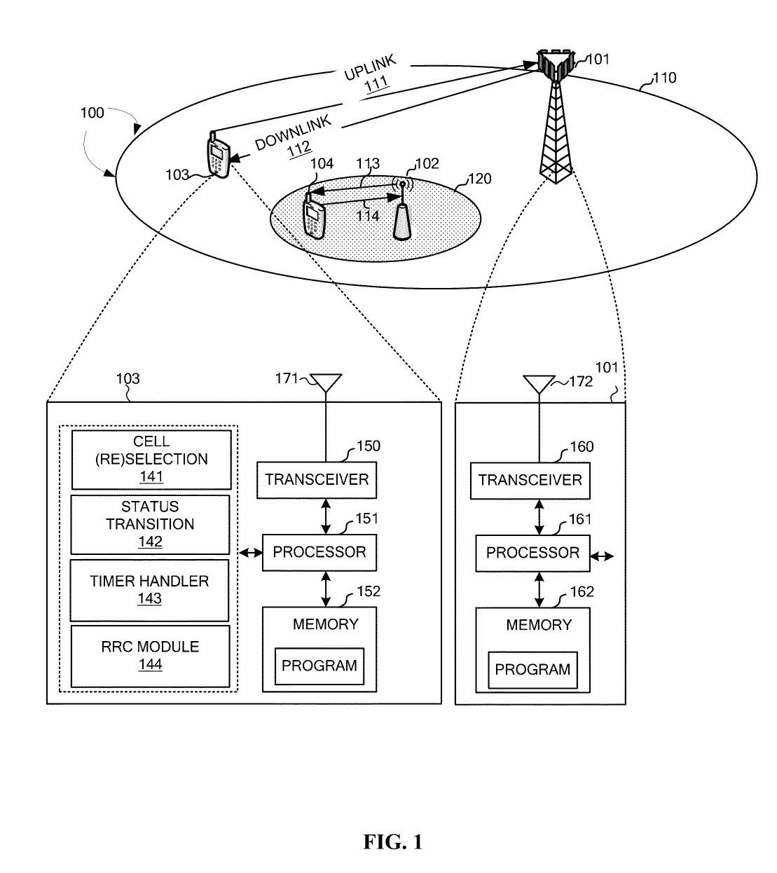

In FIG. 1, the wireless communication system 100 includes one or more fixed base infrastructure units forming a network distributed over a geographical region. The base unit may also be referred to as an access point, access terminal, base station, Node-B, eNode-B, or by other terminology used in the art. In FIG. 1, the one or more base units 101 and 102 serve a number of remote units 103 and 110 within a serving area, for example, a cell, or within a cell sector. In some systems, one or more base units are communicably coupled to a controller forming an access network that is communicably coupled to one or more core networks. The disclosure however is not intended to be limited to any particular wireless communication system.

Generally, the serving base units 101 and 102 transmit downlink communication signals 104 and 105 to remote units in the time and/or frequency domain. Remote units 103 and 110 communicate with one or more base units 101 and 102 via uplink communication signals 106 and 113. The one or more base units may comprise one or more transmitters and one or more receivers that serve the remote units. The remote units may be fixed or mobile user terminals. The remote units may also be referred to as subscriber units, mobile stations, users, terminals, subscriber stations, user equipment (UE), user terminals, or by other terminology used in the art. The remote units may also comprise one or more transmitters and one or more receivers. The remote units may have half duplex (HD) or full duplex (FD) transceivers. Half-duplex transceivers do not transmit and receive simultaneously whereas full duplex terminals do.

In one embodiment, the communication system utilizes OFDMA or a multi-carrier based architecture including Adaptive Modulation and Coding (AMC) on the downlink and next generation single-carrier (SC) based FDMA architecture for uplink transmissions. SC based FDMA architectures include Interleaved FDMA (IFDMA), Localized FDMA (LFDMA), DFT-spread OFDM (DFT-SOFDM) with IFDMA or LFDMA. In OFDMA based systems, remotes units are served by assigning downlink or uplink radio resources that typically consists of a set of sub-carriers over one or more OFDM symbols. Exemplary OFDMA based protocols include the developing Long Term Evolution (LTE) of the 3GPP UMTS standard and IEEE 802.16 standard. The architecture may also include the use of spreading techniques such as multi-carrier CDMA (MC-CDMA), multi-carrier direct sequence CDMA (MC-DS-CDMA), Orthogonal Frequency and Code Division Multiplexing (OFCDM) with one or two dimensional spreading, or may be based on simpler time and/or frequency division multiplexing/multiple access techniques, or a combination of these various techniques. In alternate embodiments, communication system may utilize other cellular communication system protocols including, but not limited to, TDMA or direct sequence CDMA.

In 3GPP LTE system based on OFDMA downlink, the radio resource is partitioned into subframes each of which is comprised of 2 slots and each slot has 7 OFDMA symbols in the case of normal Cyclic Prefix (CP). Each OFDMA symbol further consists of a number of OFDMA subcarriers depending on the system bandwidth. The basic unit of the radio resource grid is called Resource Element (RE) which spans an OFDMA subcarrier over one OFDMA symbol.

FIG. 1 further shows simplified block diagrams 160, 150 and 170 for mobile station 103, and base station 101, respectively, in accordance with the current invention. The eNB 101 has an antenna 172, which transmits and receives radio signals. A RF transceiver module 160, coupled with the antenna, receives RF signals from antenna 172, converts them to baseband signals, and sends them to processor 161. RF transceiver 162 also converts received baseband signals from processor 161, converts them to RF signals, and sends out to antenna 172. Processor 161 processes the received baseband signals and invokes different functional modules to perform features in eNB 101. Memory 162 stores program instructions and data to control the operations of eNB 101.

Mobile station 103 has an antenna 171, which transmits and receives radio signals. A RF transceiver module 150, coupled with the antenna, receives RF signals from antenna 161, converts them to baseband signals, and sends them to processor 151. RF transceiver 150 also converts received baseband signals from processor 151, converts them to RF signals, and sends out to antenna 171. Processor 151 processes the received baseband signals and invokes different functional modules to perform features in mobile station 103. Memory 152 stores program instructions and data to control the operations of mobile station 103.

Mobile station 103 further comprises some function module in the processor 151, such as cell selection/reselection module 141, used for performing cell selection/reselection, status transition module 142, used to process the operation between different status, such as RRC-IDLE, PSM and RRC_CONNECTION. And timer handler 143, used for managing the operation about multiple timers, such as T302 and T3324. And the Mobile station 103 further comprises a RRC module 144, used for managing the RRC procedure, for example to establishing a RRC connection, or to release the RRC connection. And the above modules could be implemented in the forms of software, firmware, hard ware and the combination of the above ones.

Power consumption is important for mobile terminals using battery and also for mobile terminals using external power supply. Its importance increases with the continued growth of device populations and more demanding use cases. To optimize mobile terminal power consumption, one solution is to adopt the Power Saving Mode (PSM). Power Saving Mode (PSM) is one of the solutions when there are longer periods of inactivity (in the range of multiple minutes or hours).

The basic idea for the PSM is that a UE can be configured so that the UE is reachable for downlink data only during the time that the UE is in RRC/S1 connected state plus an active time period that follows the connected state during which the UE is reachable for paging, i.e. the active timer period is after the UE changed to idle state. This active timer is defined in NAS layer for mobile terminal to enter PSM.

If a UE is capable of adopting a PSM and it wants to use the PSM it could request an Active Time value and may request a Periodic TAU/RAU Timer value during every Attach and TAU procedures. The UE does not request a Periodic TAU/RAU Timer value if it is not requesting an Active Time value. The network could not allocate an Active Time value if the UE has not requested it.

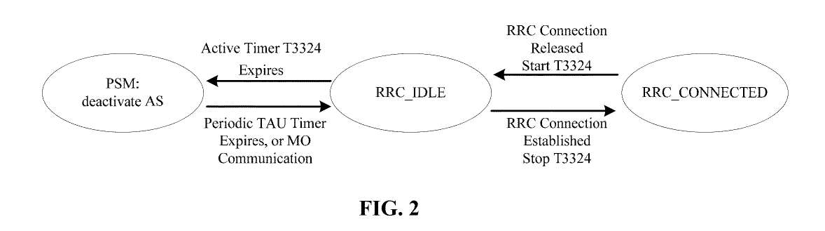

FIG. 2 illustrates an example of the state transition for PSM according to one embodiment of this invention. If the network allocates an Active Time value, the UE starts the Active timer and the MME starts the mobile reachable timer with the Active Time value allocated by the network when transitioning from RRC_CONNECTED to RRC_IDLE. The Active timer is stopped when transiting from RRC_IDLE to RRC_CONNECTED. When the Active timer expires, the UE deactivates its Access Stratum (AS) functions and enters PSM. In PSM, due to deactivation of AS functions, the UE stops all idle mode procedures, but continues to run any NAS timers that may apply, e.g. the periodic TAU timer. The UE shall resume AS functions and IDLE mode procedures before the periodic TAU timer expires for performing the periodic TAU procedure as applicable. The UE may resume idle mode procedures and Access Stratum functions any time during PSM, e.g. for mobile originating communications. Any timers and conditions that remain valid during power-off, e.g. for NAS-level back-off, apply in the same way during PSM. The state transition for PSM is shown in FIG. 2 from AS perspective. As shown in FIG. 2, when the UE is in PSM, and AS is deactivated, when the periodic TAU timer expires, or MO communications starts, so the UE transits from PSM to RRC_IDLE, and when the active Timer T3324 expires, the UE transits from RRC_IDLE to PSM. In addition, when UE is in RRC_IDLE mode, and wants to establish a RRC connection and UE stops the timer T3324, transits from RRC_IDLE to RRC_CONNECTED. When UE is in the RRC_CONNECTED mode, and when the RRC connection is released and T3324 is started, the UE goes to RRC_IDLE mode.

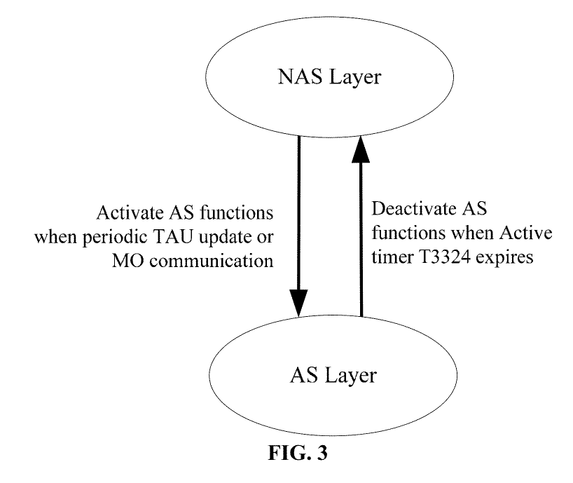

FIG. 3 illustrates the interaction between NAS layer and AS layer. For MME, when the mobile reachable timer for one UE expires and the MME stores an Active Time for the UE, the MME knows that the UE entered PSM and is not available for paging. The MME handles mobile reachable timer and availability for paging. On the UE side, the UE's AS functions are considered as deactivated during PSM. The interaction between NAS layer and AS layer is at UE side is shown in FIG. 3. In FIG. 3, for one UE, if the Active Timer T3324 expires, and the AS function is deactivated, and UE is considered to active the NAS function, and when the UE's NAS function is active, and the periodical TAU updates, or the MO communication is initialized, the AS function is active.

The introduction of PSM has some impact to the current design of LTE system. What the UE behaviors in AS layer are and how to deal with AS timers should be studied. Since PSM is a NAS state, in one case, there is no need to introduce a new state in AS state transition. While in PSM, the UE can be considered to be switched off from the point of view of AS. How to control the access barring timer when UE transits from IDLE to PSM is one of the critical problems that affects the behavior of UE when transiting from PSM back to IDLE.

In one embodiment of the disclosure, a method for a UE to access the network after transiting from PSM back to IDLE includes: keeping any running access barring timer running when the UE transits from IDLE to PSM; performing cell selection/reselection to camp on a cell when the UE transits from PSM back to IDLE (e.g. for mobile originating communication); controlling the access barring timers by comparing the cell being camped on and the previous serving cell; establishing a RRC connection based on the status of access barring timer.

In the above method, the access barring timers may be but not limited to T302, T303, T305, or T306, which is started when the RRC connection rejection or RRC connection barring during RRC connection establishment. The previous serving cell is the cell being camped on when the last time the mobile terminal transits from IDLE to PSM. This previous serving cell information can be stored at the mobile terminal when the mobile terminal transits from IDLE to PSM and during PSM. It can be used for the reference serving cell in cell reselection procedure, or to control the access barring timer so as to control the access to network for UE.

In this method, the UE starts an Active timer when transiting from Connected to Idle. In Idle state, there may be some access barring timer sis running during the RRC connection establishment, e.g., due to RRC connection rejecting or RRC connection bearing. After the Active timer at the UE expiries, the UE will enter PSM based on the current NAS specification. At this time, the access barring timer may be running before expiring. The UE keeps the access barring timer running, which means that the access barring timer is always valid before its expiry after UE enters PSM. PSM has no impact to the access barring desired by the network. The AS layer will inform upper layers about the barring alleviation after the access barring timer expiry. At the same time, the information about the previous serving cell will be stored when the UE transits from IDLE to PSM.

After the UE enters PSM, all AS functions are stopped at UE, and any running access barring timer continues running. The Cell selection/reselection procedure is also stopped during PSM even through the access barring timer is running. When UE has request to transit back to IDLE from PSM, e.g., mobile originating (MO) communications initializes or periodic TAU updates, the UE performs cell selection/reselection procedure to search a cell to camp on.

The stored information cell selection or initial cell selection can be used at the UE side. The previous serving cell when the last time the mobile terminal transits from IDLE to PSM can be considered as the stored a required by the stored information cell selection. If there is no suitable cell found in stored information cell selection, the initial cell selection will be used. The cell reselection can be also used at the UE side. The stored previous serving cell can be considered as the previous serving cell for cell reselection even though the UE has no serving cell to comp on after it enters PSM. It means that there is no impact to UE's serving cell for PSM, and the UE still can be considered as being camped on the previous serving. But there is no AS behaviors at UE in the PSM time period, such as serving or paging. If there is no suitable cell is found in cell selection/reselection procedure, the current mechanism can be used here.

If there is any running access timer when the UE transits from IDLE to PSM, it should be controlled after the cell selection/reselection procedure by comparing the camping on cell and the stored previous serving cell. If the current camping on cell is not the same as the previous serving cell, any running access barring timer is stopped. The AS layer will inform the upper layers about the barring alleviation. After that, RRC establishment can be tried immediately based on the request. If the current camping on cell is the same as the previous serving cell, any running access barring timer continues running. The access to this cell should be barred until the access barring timer expiry. At that time, the AS layer will inform the upper layers about the barring alleviation. And the request RRC connection also should be barred until the access barring timer expiry. In this case, the access barring on this cell is always valid during the running of access barring timer regardless of the UE is in PSM or IDLE. It means that PSM cannot make the access barring policy invalid for UE, which can prevent the UE cheating the network.

The intention for these access barring timers is to keep the UE for a period time not to access the network after the RRC connection rejection or RRC connection barring. In this method, the control policy of access barring to network for the UE is valid when UE enters PSM from IDLE. Any access barring timer continues running during PSM, which means the access barring state is still valid. When the UE transits from PSM back to IDLE, the network can also control the access of UE as they desired.

In another embodiment of the disclosure, a method for a UE to access the network after transiting from PSM back to IDLE includes: Stopping any running access barring timer when the UE transits from IDLE to PSM; Performing cell selection/reselection to camp on a cell when the UE transits from PSM back to IDLE (e.g. for mobile originating communication); Establishing RRC connection on the cell based on the request.

In the above method, the UE starts Active timer when transiting from Connected to Idle. In Idle state, there may be some access barring timer is running during the RRC connection establishment, e.g., due to RRC connection rejecting or RRC connection bearing. The access barring timers may be but not limited to T302, T303, T305, or T306. After the Active timer at the UE expiry, the UE will enter PSM based on the current NAS specification. At this time, the UE stops all running access barring timers if there is any, which means that the access barring timer is invalid when UE enters PSM. At the stopping of any Access barring timer, the AS function informs upper layers about the barring alleviation. Thus, the access alleviation is performed in advance after the UE enters PSM.

After the UE enters PSM, all AS functions are stopped, which also includes the behaviors of all access barring timers. The access barring timers are always stopped during PSM. When UE has request to transit back to IDLE from PSM, e.g., mobile originating communications or periodic TAU update, the UE performs cell selection/reselection procedure to search a cell to camp on. The stored previous serving cell can be considered as the previous serving cell for cell reselection procedure. If there is no suitable cell is found, the current mechanism can be sued here. After that, the UE can establish RRC connection on the camping on cell based on the request.

In this method, the control of access barring to network for the UE is invalid when UE enters PSM from IDLE. And the UE is considered to be switched off from AS point of view. All access barring timers are stopped during PSM. When the UE transits from PSM back to IDLE, the UE is considered to be powered on in AS layer, and performs the similar procedure when powered-on.

Some further details are the above embodiments are given below.

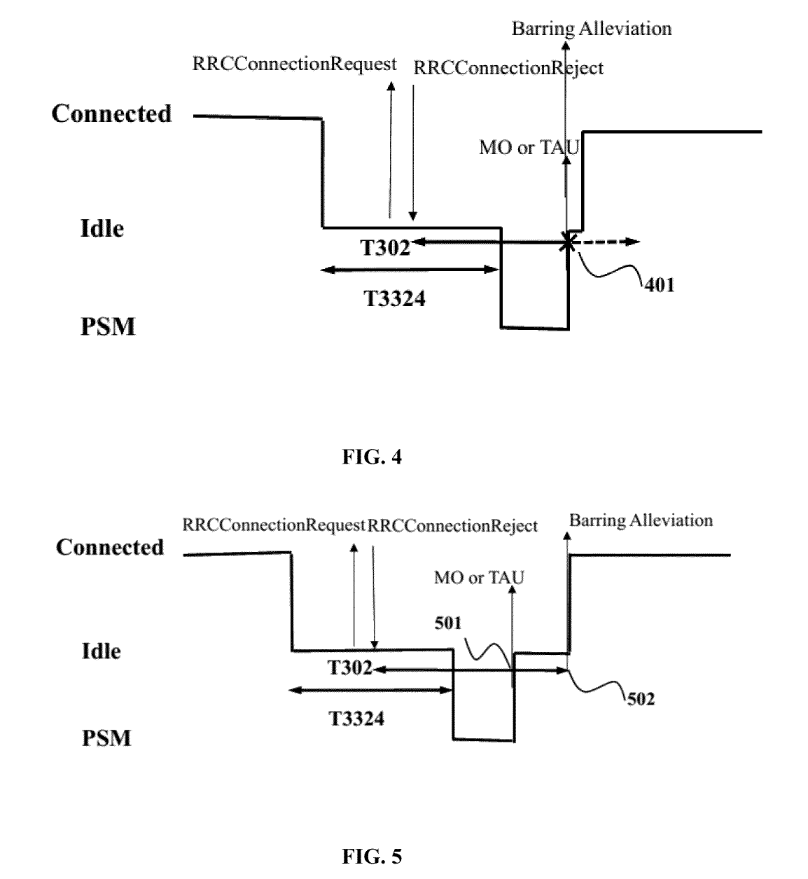

FIG. 4 illustrates an example of a UE accessing the network with running access barring timer (camp on a same cell). FIG. 5 illustrates an example of a UE accessing the network with running access barring timer (camp on a different cell).

Referring now to FIG. 4 and FIG. 5, in one embodiment of the disclosure, a method for a UE to access the network after transiting from PSM back to IDLE includes: keeping the running access barring timer T302 (or T303, T305, T306) running when the UE transits from IDLE to PSM; performing cell selection/reselection to camp on a cell when the UE transits from PSM back to IDLE for mobile originating communication or TAU update; controlling the access barring timers T302 (or T303, T305, T306) by comparing the cell being camped on and the previous serving cell; establishing RRC connection based on the status of access barring timer T302 (or T303, T305, T306).

After transiting from Connected to Idle, the UE starts Active timer T3324. In Idle state, there is a RRC connection request. Unfortunately, this RRC connection establishment is rejected. Thus, the access barring timer T302 starts. During the running of this timer, the Active timer T3324 expiries, so the UE enters PSM based on the current NAS specification. At the same time, the information about the previous serving cell will be stored when UE transits from IDLE to PSM. After the UE enters PSM, all AS functions are stopped at UE side, and the running access barring timer T302 continues running.

During PSM, if there is a mobile originating (MO) call or TAU update procedure is initialized before the access barring timer T302 expiries, the UE transits from PSM back to IDLE. The UE will perform cell selection/reselection procedure to search a cell to camp on. The stored previous serving cell can be considered as the previous serving cell for cell reselection procedure.

At the UE side, if the current camping on cell is not the same as the previous serving cell, the access barring timer T302 should be stopped at point 401 as shown in FIG. 4. The AS layer will inform upper layers about the barring alleviation. After that, RRC establishment can be tried immediately based on the request. If the current camping on cell is the same as the previous serving cell as shown in FIG. 5, the access barring timer T302 continues running. And the request RRC connection also should be barred at this time as desired by the network. After the access barring timer T302 expiries at point 501, the AS layer will inform upper layers about the barring alleviation at point 502. And the RRC establishment can be tried based on the request.

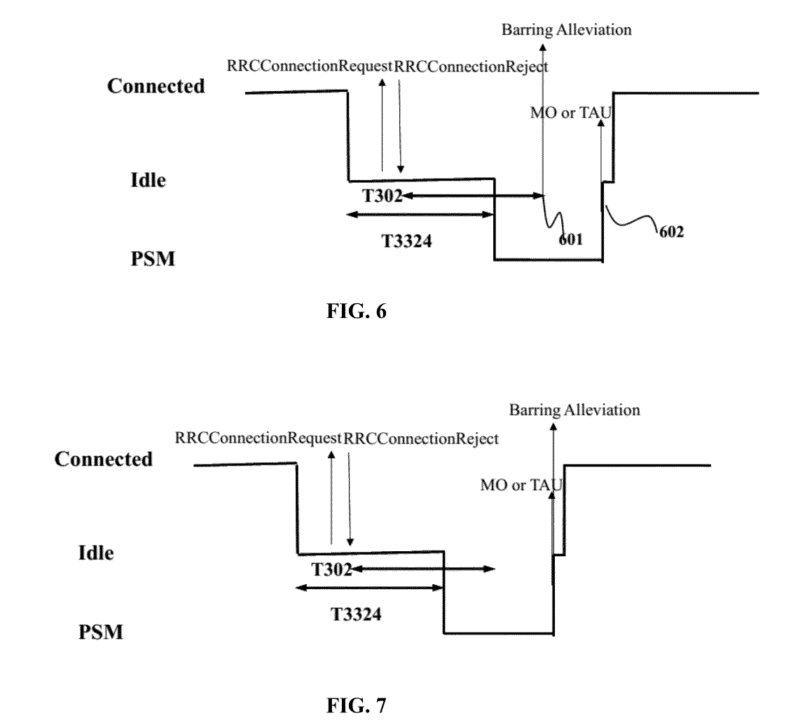

FIG. 6 illustrates an example of T302 expiry before transition from PSM to IDLE. FIG. 7 illustrates an example of T302 expiry before transition from PSM to IDLE. Referring now to FIG. 6 and FIG. 7, in one embodiment of the disclosure, a method for a UE to access the network after transiting from PSM back to IDLE includes: keeping the running access barring timer T302 (or T303, T305, T306) running when the UE transits from IDLE to PSM; The access barring timers T302 (or T303, T305, T306) expires during PSM at point 601; Performing cell selection/reselection to camp on a cell at point 602 when the UE transits from PSM back to IDLE for mobile originating communication or TAU update; Establishing RRC connection based on the request.

After transiting from Connected to Idle, the UE starts Active timer T3324. In Idle state, there is a RRC connection request. Unfortunately, this RRC connection establishment is rejected. Thus, the access barring timer T302 starts. During the running of this timer, the Active timer T3324 expiry, so the UE enters PSM based on the current NAS specification. At the same time, the information about the previous serving cell will be stored when UE transits from IDLE to PSM. After the UE enters PSM, all AS functions are stopped at UE side, and the running access barring timer T302 continues running.

During PSM, the access barring timer T302 expires. One embodiment of the disclosure is that the AS layer will immediately inform upper layers about the barring alleviation during PSM at point 601 as shown in FIG. 6. Another embodiment of the disclosure is that the AS layer will inform upper layers about the barring alleviation after the UE transits from PSM back to IDLE as shown in FIG. 7. If there is a mobile originating call or TAU update procedure is initialized before T302 expiries, the UE transits from PSM back to IDLE. The UE will perform cell selection/reselection procedure to search a cell to camp on. The stored previous serving cell can be considered as the previous serving cell for cell reselection procedure. And the RRC establishment can be tried based on the request.

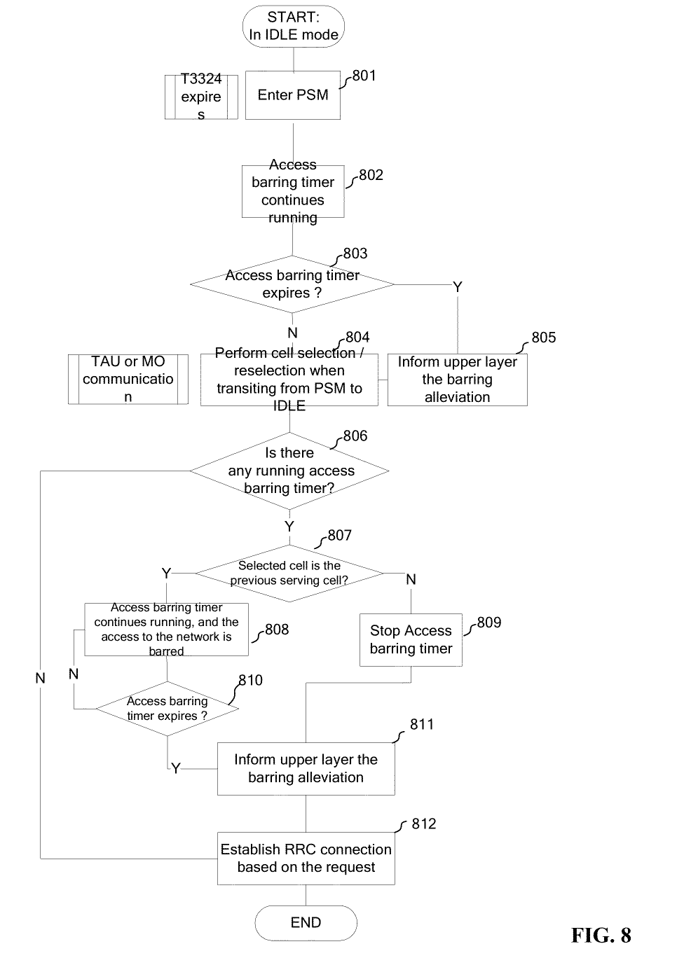

The procedure for the above two embodiments of the disclosure is shown in FIG. 8. In this procedure, the access barring timer continues running after the UE enters PSM. If the access barring timer expires before the UE transits from PSM back to IDLE, the AS layer will immediately inform upper layers about the barring alleviation during PSM, or after the UE transits from PSM back to IDLE. The UE performs cell selection/reselection procedure to search a cell to camp on when there is TAU update or mobile originating communication. After that, the RRC establishment can be tried based on the request. In detail, first UE is in IDLE mode, when T3324 timer expires, the UE enters into PSM in step 801. The UE keeps the access barring timer running in step 802. And then, the UE determines if the access barring timer expires in step 803, if yes, the UE goes to step 805 and informs the upper layer about the barring alleviation, or else, when the TAU update procedure or MO communication procedure is initialized, the UE goes to step 804 to perform cell selection/reselection when transiting from PSM to IDLE. And after that, the UE determines if there is any running access barring timer in step 806, if no, the UE establishes a RRC connection based on the TAU update procedure or MO communication procedure request in step 812, or if it is yes in step 806, the UE further determines if the selected cell is the previous serving cell in step 807. If it is the previous serving cell, the UE keeps the access barring timer running, and the access procedure to the network is barred in step 808, if the selected cell is not the previous serving cell, the UE stops the access barring timer in step 809 and goes to step 811 to informs the upper layer the barring alleviation in step 811, and established a RRC connection based on the request in step 812. During the above procedure, after step 808, the UE further determines if the access barring timer expires in step 810, if it does not expires, then goes back to step 818. If it does expiry, then the UE goes to step 811.

If the access barring timer does not expire before the UE transits from PSM back to IDLE, the UE performs cell selection/reselection procedure to search a cell to camp on when there is TAU update or mobile originating communication. After the UE camps on a cell, if the current camping on cell is not the same as the previous serving cell, the access barring timer should be stopped. The AS layer will inform upper layers about the barring alleviation. After that, RRC establishment can be tried immediately based on the request. If the current camping on cell is the same as the previous serving cell, the access barring timer continues running. And the request RRC connection also should be barred at this time as desired by the network. After the access barring timer expiries, the AS layer will inform upper layers about the barring alleviation. And the RRC establishment can be tried based on the request.

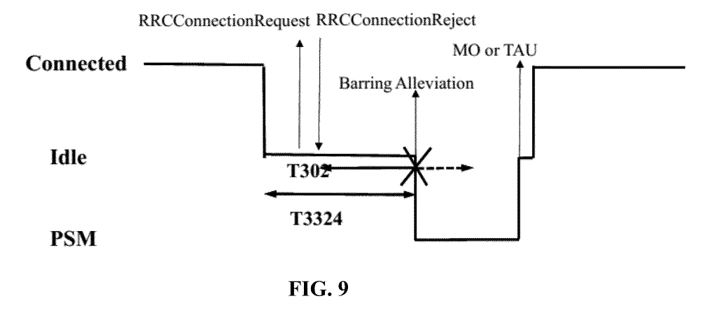

Referring now to FIG. 9, FIG. 9 illustrates an example of a UE accesses the network with stopping access barring timer. In one embodiment of the disclosure, a method for a UE to access the network after transiting from PSM back to IDLE includes: stopping the running access barring timer T302 (or T303, T305, T306) when the UE transits from IDLE to PSM; performing cell selection/reselection to camp on a cell when the UE transits from PSM back to IDLE (e.g. for mobile originating communication); establishing RRC connection on the cell based on the request.

After transiting from Connected to Idle, the UE starts Active timer T3324. In Idle state, there is a RRC connection request. Unfortunately, this RRC connection establishment is rejected. Thus, the access barring timer T302 starts. During the running of this timer, the Active timer T3324 expiries, so the UE enters PSM based on the current NAS specification. At the same time, the information about the previous serving cell will be stored when the UE transits from IDLE to PSM. After the UE enters PSM, all AS functions are stopped at UE side, and the running access barring timer T302 is stopped. The AS function informs upper layers about the barring alleviation.

During PSM, there is no running access barring timer. All AS functions including the behaviors of all access barring timers are stopped. When the UE has request to transit back to IDLE from PSM, e.g., mobile originating communications or periodic TAU update, the UE performs cell selection/reselection procedure to search a cell to camp on. The stored previous serving cell can be considered as the previous serving cell for cell reselection procedure. After that, the UE can establish RRC connection on the camping on cell based on the request.

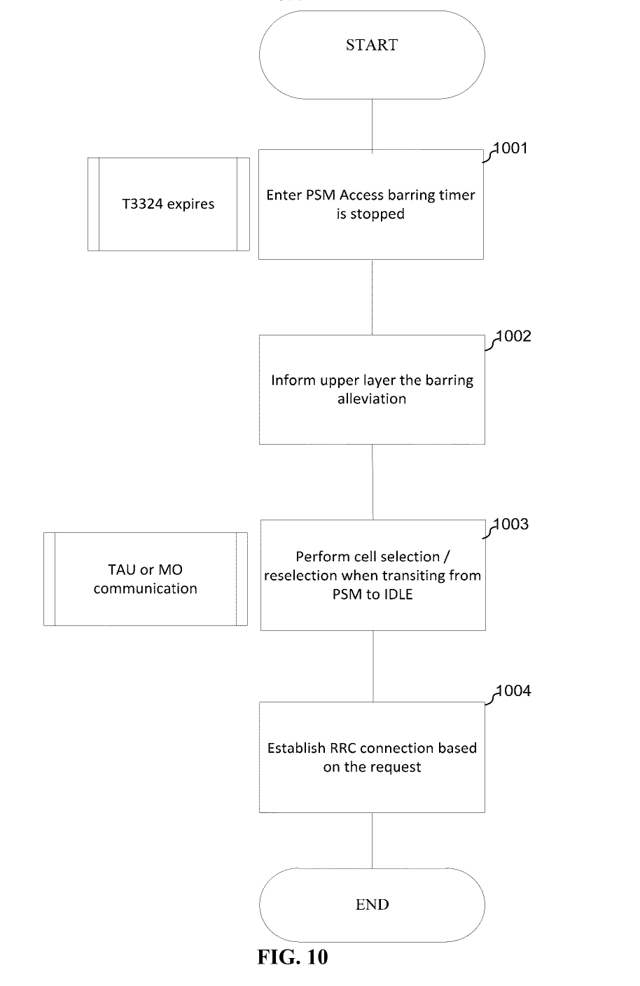

FIG. 10 illustrates the method flow of a UE accesses the network with stopping access barring timer. In FIG. 10, first, UE is in RRC_IDLE mode, and when T3324 timer expires, the UE enters into PSM, and an access baring timer is stopped in step 1002. And then the UE informs the upper layer about the barring alleviation in step 1002. When a TAU update procedure or a MO communication is initialized, the UE perform cell selection/reselection when transiting from PSM to IDLE in step 1003. And then the UE establishes a RRC connection based on the request about TAU update procedure or a MO communication in step 1004.

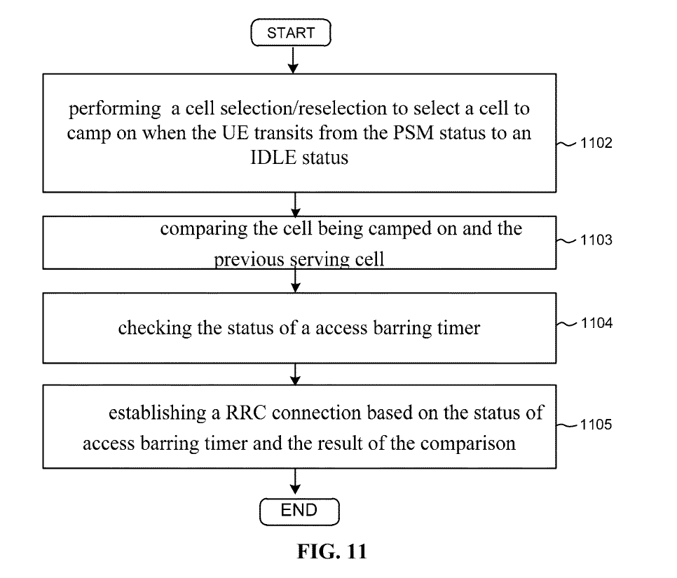

FIG. 11 illustrates another method flow of a UE accesses the network according to the access barring timer. First, in step 1102, the UE performs a cell selection/reselection to select a cell to camp on when the UE transits from the PSM status to an IDLE status. In step 1103, the UE further compares the cell being camped on and the previous serving cell. In step 1104, the UE checks the status of a access barring timer. And in step 1105, the UE establishes a RRC connection based on the status of access barring timer and the result of the comparison.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

1. A method comprising:
performing a cell selection/reselection to select a cell to camp on when the UE transits from a Power Saving Mode (PSM) status to an IDLE status by a user equipment (UE) in a mobile communication system;
comparing the cell being camped on and the previous serving cell;
checking the status of a access barring timer; and
establishing a RRC connection based on the status of access barring timer and the result of the comparison.

2. The method of claim 1, wherein the access barring timer comprises one of the following timers, T302, T303, T305 and T306.

3. The method of claim 1, wherein the access barring timer is activated when one of the following conditions occur: the RRC connection is established, the RRC connection quest is rejected, and the RRC connection is barred.

4. The method of claim 1, wherein establishing a RRC connection based on the status of access barring timer and the result of the comparison further comprising:
establishing a RRC connection when the access barring timer expires or stopped.

5. The method of claim 4, wherein when a selected cell is not the a previous serving cell camped on when the last time the UE transits from IDLE to PSM, or the serving cell during the cell resection, the access barring timer is stopped.

6. The method of claim 4, wherein when a selected cell is a previous serving cell camped on when the last time the UE transits from IDLE to PSM, or the serving cell during the cell resection, the access barring timer is kept running.

7. The method of claim 4, wherein when the access barring timer is stopped or expires, the information about barring alleviation is informed to the upper layer by the UE.

8. An user equipment (UE), comprising:
cell selection module, for performing a cell selection/reselection to select a cell to camp on by a UE in a mobile communication system when the UE transits from a Power Saving Mode (PSM) status to an IDLE status and comparing the cell being camped on and the previous serving cell;
timer handler for checking the status of a access barring timer;
RRC module, for establishing a RRC connection based on the status of access barring timer and the result of the comparison.

9. The user equipment of claim 8, wherein the access barring timer comprises one of the following timers, T302, T303, T305 and T306.

10. The user equipment of claim 8, wherein the access barring timer is activated when one of the following conditions occur: the RRC connection is established, the RRC connection quest is rejected, and the RRC connection is barred.

11. The user equipment of claim 8, wherein RRC module, for establishing a RRC connection based on the status of access barring timer and the result of the comparison further comprising:
establishing a RRC connection when the access barring timer expires or stopped.

12. The user equipment of claim 11, wherein when a selected cell is not the a previous serving cell camped on when the last time the UE transits from IDLE to PSM, or the serving cell during the cell resection, the access barring timer is stopped.

13. The user equipment of claim 11, wherein when a selected cell is a previous serving cell camped on when the last time the UE transits from IDLE to PSM, or the serving cell during the cell resection, the access barring timer is kept running.

14. The user equipment of claim 11, wherein when the access barring timer is stopped or expires, the information about barring alleviation is informed to the upper layer by the UE.
